(19) United States
(12) Patent Application Publication
(10) Pub. No.: US 2020/0256565 A1
(43) Pub. Date: Aug. 13, 2020

(54) STOVETOP COVERING SYSTEM

(71) Applicant: Micheal Kieren, West Bend, WI (US)

(72) Inventor: Micheal Kieren, West Bend, WI (US)

(21) Appl. No.: 16/053,274

(22) Filed: Aug. 2, 2018

(51) Int. Cl. F24C 15/36; G01K 11/12

(52) U.S. Cl. CPC F24C 15/36; G01K 11/12

(57) ABSTRACT

A burner cover for a flat top stove that includes: a top surface; an open enclosure, where the open enclosure is adapted for placement over a burner; and a means to transition color of the burner cover. The burner cover includes a first color and a second color. The first color is activated upon placement over a heated burner and said second color is activated after the burner cools to a preset temperature.

### BACKGROUND OF THE INVENTION

### Field of Invention

The present invention relates to a cover that is provided for a burner on a flat surface stove.

### Description of Related Art

The use of flat top ceramic electric stoves are featured in many households. The flat surface stovetop provides a uniquely aesthetic view and design for the user. The burners for this particular electric stove are positioned under the surface of the stovetop. The burners are usually designated with some type of circle or a color differential to locate the burner on the stovetop. The burner radiates heat to the top surface for use therefore it is imperative that either a pot or skillet is placed over the burner while in use and further that the user is alert of any recently used burner. As a consequence, the burner remains hot after being shut in the off position and cooling takes place over a period of time. While the burner is still hot from prior use, it can become a burn hazard for a user in an owner's home. As a result, it would be advantageous to have a cover designed for placement over a hot burner until the burner is in a cool state.

### SUMMARY OF THE INVENTION

The present invention relates to a burner cover for a flat top stove that includes: a top surface; an open enclosure, where the open enclosure is adapted for placement over a burner; and a means to transition color of the burner cover. The burner cover includes a first color and a second color. The first color is activated upon placement over a heated burner and said second color is activated after the burner cools to a preset temperature.

### BRIEF DESCRIPTION OF DRAWINGS

FIG. 1 depicts use of a burner cover system in accordance with the present invention.

### DETAILED DESCRIPTION

The present invention relates to a burner cover for placement over a flat surface stovetop. The stovetop cover of the present invention covers a recently used burner that lingers in a heated state after use. The cover according in the present invention includes a color transition. The covers are not flammable and do not absorb heat from the burner and therefore remain cool when placed over the hot burner. The burner covers have a means to detect the underlying heat and therefore presents a first color when the burner is hot and as the burner cools the cover transitions to a second color. This feature enables the user to have notice of the status of the underlying burner.

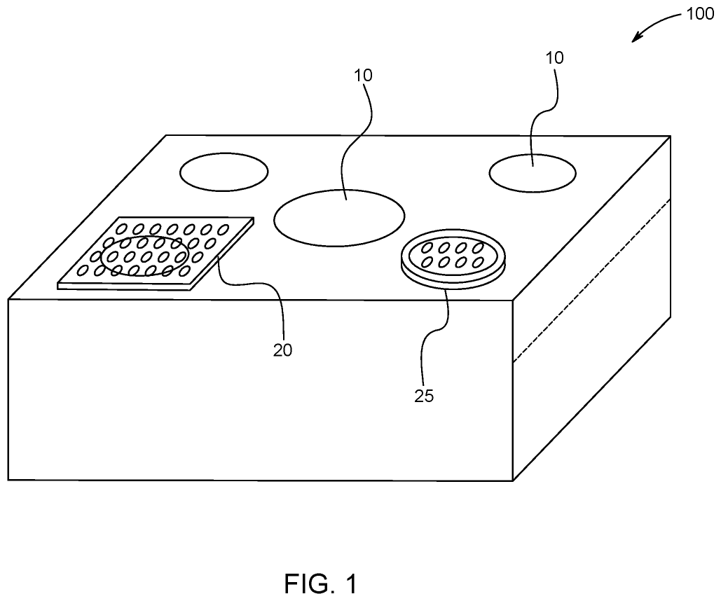

FIG. 1 depicts use of a first burner cover 20 and a second burner cover 25 on a stovetop 100. The stovetop burners as shown in FIG. 1 are on a flat surface ceramic stovetop with a number of burners 10 as shown in FIG. 1. The two embodiments of the covers are depicted, where a first cover 20 is shown in a rectangular shape for placement over an underlying burner. A second cover 25 is also depicted with a circular shape and covers a smaller surface for use for smaller sized burners. The placement of the covers over a burner protects the user and reduces the likelihood of burn injuries. Each cover includes a color transition technology wherein the first color of a cover is depicted when the burner is in a hot position and a second color is displayed when the burner has cooled off.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A burner cover for a flat top stove comprising:
a. a top surface;
b. an open enclosure, where the open enclosure is adapted for placement over a burner; and
c. a means to transition color of the burner cover.

2. The burner cover according to claim 1, where the burner cover includes a first color and a second color.

3. The burner cover according to claim 2, where the first color is activated upon placement over a heated burner and said second color is activated after the burner cools to a preset temperature.
